(19) United States
(12) Patent Application Publication
(10) Pub. No.: US 2008/0281594 A1
(43) Pub. Date: Nov. 13, 2008

(54) Autoscriber

(75) Inventor: Paul Roberts Koenig, Clearwater, FL (US)

Correspondence Address: Paul R. Koenig, 939 Mandalay Avenue, Clearwater, FL, 33767, US

(73) Assignee: Paul Roberts Koenig, Clearwater, FL (US)

(21) Appl. No.: 11/800,744

(22) Filed: May 8, 2007

(51) Int. Cl. G10L 15/06

(52) U.S. Cl. 704/246

(57) ABSTRACT

The Autoscriber invention pertains to a system of inserting a printed SMPTE timecode into a textual representation of the spoken portion of a media recording. The system includes a user-supplied computer with Autoscriber (voice recognition) software, a printer and a user-supplied media recorder/player with SMPTE timecode reader and RS-422 data output.

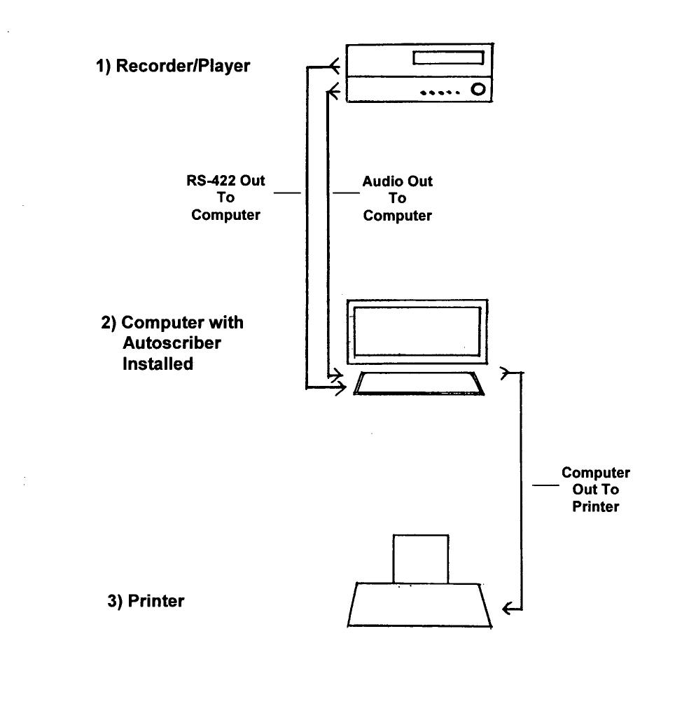

The media recorder/player is connected with the computer. As the media plays, its' audio is outputted to the computer. The SMPTE timecode is also outputted to the computer.

Autoscriber processes the spoken portion of the media into a textual data file. Autoscriber also annotates the data file with SMPTE timecode every fifteen seconds (:15) in synchronization with the spoken portion of the media.

The computer data file can then be used to select portions of the speech utilizing the exact timecode of the original media, either on another computer or as a printed text document.

Autoscriber is the title of a system to assist television producers in the labor and time intensive task of transcribing the spoken portion of a video/media recording.

### BACKGROUND

In the field of producing television, film or other media productions on-camera interviews are essential elements of such productions. Interviews are photographed (shot) in a field or studio setting. SMPTE timecode (TC) is recorded in synchronization with picture and sound. After interviews are shot the producers and editors blend pertinent comments of the interviewee(s) into the program. To select the various portions of interviews the producer must review each of the tapes, films or other media.

For reasons of safety and to maintain the qualitative integrity of the original media it is common practice to reproduce (copy) the interview to a low-quality (cheaper) media format. The TC of the original recording is superimposed over the image. Media formats such as VHS and DVD are often used for this purpose. Viewing the copy allows the producer to identify particular portions of the recorded interview.
A variation of this process is that the spoken portion of the media copy be manually transcribed so the producer can review a textual representation of the words. The TC is manually annotated at the beginning of each interviewee statement.
The copying process must occur in real-time; thus, an hour-long interview takes at least an hour to copy. With subsequent manual transcription the process takes substantially longer due to the transcriber reviewing the statements more than once to accurately reflect the precise spoken words.

General Idea of Autoscriber

The general idea of Autoscriber is to produce a data file and/or printout of the spoken portion of interviews utilizing voice recognition and annotation with TC in a nearly automatic process.

The audio output and TC signal of a media recorder/player are inputted to a computer equipped with Autoscriber, a proprietary TC interface and a printer connected to the computer. Autoscriber, with its' voice recognition capability, produces a data file annotated with synchronous TC.

Subsequently, the producer can swiftly review the data file on a laptop computer. Additionally, the producer may choose to review a hard copy text of the data file in a setting which does not require manual involvement with a media player, such as an airplane or home office.
Having identified and noted on a script the TC of pertinent portions of interviews the producer and editor can rapidly locate particular portions of the recorded speech on the original, high-quality media during the editing process.

### BRIEF DESCRIPTION OF THE DRAWING

The Autoscriber drawing includes the following components, as illustrated in the accompanying drawing:

1) A media recorder/players' audio output is connected to the computers' audio input; the media recorder/players' TC output is connected to a second (discrete) input of the computer (ideally an RS-422 interface;)

2) The computer is configured with Autoscriber to automatically recognize the recorded speech and combine it with the TC signal. The TC annotation occurs at fifteen second (:15) intervals in sync with the spoken words;

3). The outputs of the Autoscriber system are a data file and/or a printed document.

### DETAILED DESCRIPTION OF OPERATION

With the Autoscriber system installed on the computer and all audio and TC connections made between the media recorder/player and computer, the system is easily operated by anyone with minimal training.
1) The Autoscriber system is opened on the computer;
2) The operator loads the original recording in the media reorder/player;
3) Using the transport controls on the media recorder/player, the operator positions the recording at the beginning of the media;
4) The operator plays the portion of the media in which the interviewee reads the Autoscriber recognition paragraph;
5) When Autoscriber indicates readiness the operator presses the Start button;
6) Unattended, the system transcribes the media then shuts off when it senses the end of recorded speech;
7) When the operator returns the media is rewound to the start and the data file is ready for subsequent use.

1. The Autoscriber system was created by Paul Koenig on Apr. 1, 2007. It includes the following components:
1) A user-supplied computer with Autoscriber voice recognition software;
2) A user-supplied media recorder/player with audio and SMPTE time code outputs connected to the computer;
3) A printer connected to the computer.
The claim is Autoscriber can near-automatically transcribe recorded speech with SMPTE timecode annotation without the labor and time intensive investment of a person manually performing or attending the process.
As indicated in the accompanying Drawing, Autoscriber may be configured in a simple, single station unit. It may also be configured in an enterprise-wide application where Autoscriber would be a destination on a switching matrix while any media recorder/player in a facility could be designated as its input source.
Autoscriber may be used with any language for which voice recognition software has been developed. Novel features of future models of Autoscriber include performance of the transcription process at speeds greater than real-time for even greater savings of time and labor.
